(19) United States
(12) Patent Application Publication
(10) Pub. No.: US 2021/0148495 A1
(43) Pub. Date: May 20, 2021

(54) FERRULE ARRANGEMENTS FOR A CONDUIT FITTING

(71) Applicant: Swagelok Company, Solon, OH (US)

(72) Inventors: Kelli Sandra Swan, Northfield, OH (US); Theodore J. Gausman, Lyndhurst, OH (US); Cal R. Brown, Lyndhurst, OH (US); Gregory S. Kalata, Avon, OH (US); Peter C. Williams, Cleveland Heights, OH (US); Donald E. Negrelli, Gates Mills, OH (US); Mark D. Bearer, Akron, OH (US)

(21) Appl. No.: 16/636,684

(22) PCT Filed: Aug. 3, 2018
(86) PCT No.: PCT/US18/45099

§ 371 Date: Feb. 5, 2020

Related U.S. Application Data
(60) Provisional application No. 62/542,491, filed on Aug. 8, 2017.

(51) Int. Cl. F16L 19/065

(52) U.S. Cl. CPC F16L 19/0653

(57) ABSTRACT

A preassembly for a conduit fitting includes a fitting nut, a ferrule disposed within the fitting nut, and a retaining feature configured to retain the ferrule with the fitting nut prior to assembly of the fitting nut with a fitting body, such that the ferrule is axially spaced from a drive surface of the fitting nut. When the fitting nut is assembled with a fitting body on a conduit end, axially movement of the ferrule toward the drive surface of the fitting nut causes deformation of the retaining feature to release the ferrule from the fitting nut.

### CROSS-REFERENCE TO RELATED APPLICATION

This application claims priority to and all benefit of U.S. Provisional Patent Application Ser. No. 62/542,491, filed on Aug. 8, 2017, for FERRULE ARRANGEMENTS FOR A CONDUIT FITTING, the entire disclosure of which is fully incorporated herein by reference.

### TECHNICAL FIELD OF THE INVENTIONS

The present disclosure relates to fittings for making mechanically attached connections between a conduit and another fluid component, for containing liquid or gas fluids. More particularly, the disclosure relates to fittings for tube and pipe conduits that use a conduit gripping device, such as for example, one or more ferrules.

### SUMMARY OF THE DISCLOSURE

In accordance with an embodiment of one or more of the inventions presented in this disclosure, a ferrule for a conduit fitting includes an interior wall extending along a central axis through the ferrule between first and second end portions so that the ferrule can be installed over a conduit end, an enlarged central portion disposed axially between and extending radially outward of the first and second end portions, and a retaining projection extending radially outward from the enlarged central portion. The ferrule is functionally symmetrical about a plane that bisects an axial center point of the ferrule.

In accordance with another embodiment of one or more of the inventions presented in this disclosure, a preassembly for a conduit fitting includes an annular fitting component, a conduit gripping device, and a retaining feature. The conduit gripping device is disposed within the annular fitting component, and is functionally symmetrical about a plane that bisects an axial center point of the conduit gripping device. The retaining feature is configured to retain the conduit gripping device with the annular fitting component prior to assembly of the annular fitting component with a mating fitting component.

In accordance with another embodiment of one or more of the inventions presented in this disclosure, a preassembly for a conduit fitting includes a fitting nut, a ferrule, and a retaining feature. The ferrule is disposed within the fitting nut, and includes an interior wall extending along a central axis through the ferrule between a first end portion proximate to a drive surface of the fitting nut and a second end portion distal to the drive surface, and an enlarged central portion disposed axially between and extending radially outward of the first and second end portions. The retaining feature is configured to engage the first end portion of the ferrule to retain the ferrule with the fitting nut prior to assembly of the fitting nut with a fitting body. When the fitting nut is assembled with a fitting body on a conduit end, the first and second end portions are compressed radially inward against the conduit end and the central portion is bowed radially outward, wherein the radially inward compression of the first end portion causes the ferrule to disengage from the retaining feature to permit disassembly of the fitting nut from the ferrule.

In accordance with another embodiment of one or more of the inventions presented in this disclosure, a preassembly for a conduit fitting includes a fitting nut, a ferrule, and a retaining feature. The ferrule is disposed within the fitting nut, and includes an interior wall extending along a central axis through the ferrule between a first end portion proximate to a drive surface of the fitting nut and a second end portion distal to the drive surface, and an enlarged central portion disposed axially between and extending radially outward of the first and second end portions. The retaining feature is configured to engage the enlarged central portion of the ferrule to retain the ferrule with the fitting nut prior to assembly of the fitting nut with a fitting body. When the fitting nut is assembled with a fitting body on a conduit end, the first and second end portions are compressed radially inward against the conduit end and the central portion is bowed radially outward, wherein the radially outward bowing of the enlarged central portion causes the ferrule to disengage from the retaining feature to permit disassembly of the fitting nut from the ferrule.

In accordance with another embodiment of one or more of the inventions presented in this disclosure, a preassembly for a conduit fitting includes an annular fitting component, first and second conduit gripping devices, and a retaining feature. The retaining feature configured to retain the first conduit gripping device with the annular fitting component prior to assembly of the annular fitting component with a mating fitting component. The second conduit gripping device is disposed between the first conduit gripping device and a drive surface of the annular fitting component, and is functionally symmetrical about a plane that bisects an axial center point of the second conduit gripping device.

In accordance with another embodiment of one or more of the inventions presented in this disclosure, a preassembly for a conduit fitting includes a fitting nut, a ferrule disposed within the fitting nut, and a retaining feature configured to retain the ferrule with the fitting nut prior to assembly of the fitting nut with a fitting body, such that the ferrule is axially spaced from a drive surface of the fitting nut. When the fitting nut is assembled with a fitting body on a conduit end, axially movement of the ferrule toward the drive surface of the nut causes deformation of the retaining feature to release the ferrule from the fitting nut.

These and other aspects and advantages of the inventions described herein will be readily appreciated and understood by those skilled in the art in view of the accompanying drawings.

### BRIEF DESCRIPTION OF THE DRAWINGS

FIG. 1 is a longitudinal cross-sectional schematic view of a conventional single ferrule conduit fitting assembly, shown in a finger tight condition;

FIG. 2 is a half-longitudinal cross-sectional view of a fitting nut and ferrule in accordance with an exemplary embodiment of the present application, shown prior to cartridging preassembly;

FIG. 2A is a half-longitudinal cross-sectional view of the fitting nut and ferrule of FIG. 2, shown in a cartridged condition;

FIG. 2B is a half-longitudinal cross-sectional view of the fitting nut and ferrule of FIG. 2, shown assembled with a fitting body;

FIG. 3 is a half-longitudinal cross-sectional view of a fitting nut and ferrule in accordance with another exemplary embodiment of the present application, shown prior to cartridging preassembly;

FIG. 3A is a half-longitudinal cross-sectional view of the fitting nut and ferrule of FIG. 3, shown in a cartridged condition;

FIG. 3B is a half-longitudinal cross-sectional view of the fitting nut and ferrule of FIG. 3, shown assembled with a fitting body;

FIG. 4 is a half-longitudinal cross-sectional view of a fitting nut and ferrule in accordance with another exemplary embodiment of the present application, shown prior to cartridging preassembly;

FIG. 4A is a half-longitudinal cross-sectional view of the fitting nut and ferrule of FIG. 4, shown in a cartridged condition;

FIG. 4B is a half-longitudinal cross-sectional view of the fitting nut and ferrule of FIG. 4, shown assembled with a fitting body;

FIG. 5 is a half-longitudinal cross-sectional view of a fitting nut and ferrule in accordance with another exemplary embodiment of the present application, shown prior to cartridging preassembly;

FIG. 5A is a half-longitudinal cross-sectional view of the fitting nut and ferrule of FIG. 5, shown in a cartridged condition;

FIG. 5B is a half-longitudinal cross-sectional view of the fitting nut and ferrule of FIG. 5, shown assembled with a fitting body;

FIG. 6 is a half-longitudinal cross-sectional view of a fitting nut and ferrule in accordance with another exemplary embodiment of the present application, shown prior to cartridging preassembly;

FIG. 6A is a half-longitudinal cross-sectional view of the fitting nut and ferrule of FIG. 6, shown in a cartridged condition;

FIG. 6B is a half-longitudinal cross-sectional view of the fitting nut and ferrule of FIG. 6, shown assembled with a fitting body;

FIG. 7 is a half-longitudinal cross-sectional view of a fitting nut and ferrule in accordance with another exemplary embodiment of the present application, shown prior to cartridging preassembly;

FIG. 7A is a half-longitudinal cross-sectional view of the fitting nut and ferrule of FIG. 7, shown in a cartridged condition;

FIG. 7B is a half-longitudinal cross-sectional view of the fitting nut and ferrule of FIG. 7, shown assembled with a fitting body;

FIG. 8 is a half-longitudinal cross-sectional view of a fitting nut and ferrule in accordance with another exemplary embodiment of the present application, shown prior to cartridging preassembly;

FIG. 8A is a half-longitudinal cross-sectional view of the fitting nut and ferrule of FIG. 8, shown in a cartridged condition;

FIG. 8B is a half-longitudinal cross-sectional view of the fitting nut and ferrule of FIG. 8, shown assembled with a fitting body;

FIG. 9 is a half-longitudinal cross-sectional view of a fitting nut and ferrule in accordance with another exemplary embodiment of the present application, shown prior to cartridging preassembly;

FIG. 9A is a half-longitudinal cross-sectional view of the fitting nut and ferrule of FIG. 9, shown in a cartridged condition;

FIG. 9B is a half-longitudinal cross-sectional view of the fitting nut and ferrule of FIG. 9, shown assembled with a fitting body;

FIG. 10 is a half-longitudinal cross-sectional view of a fitting nut and ferrule in accordance with another exemplary embodiment of the present application, shown prior to cartridging preassembly;

FIG. 10A is a half-longitudinal cross-sectional view of the fitting nut and ferrule of FIG. 10, shown in a cartridged condition;

FIG. 11 is a half-longitudinal cross-sectional view of a fitting nut and ferrule in accordance with another exemplary embodiment of the present application, shown in a cartridged condition;

FIG. 11A is a half-longitudinal cross-sectional view of the fitting nut and ferrule of FIG. 11, shown assembled with a fitting body;

FIG. 12 is a half-longitudinal cross-sectional view of a fitting nut and ferrule in accordance with another exemplary embodiment of the present application, shown in a cartridged condition;

FIG. 12A is a half-longitudinal cross-sectional view of the fitting nut and ferrule of FIG. 12, shown assembled with a fitting body;

FIG. 13 is a half-longitudinal cross-sectional view of a fitting nut and ferrule in accordance with another exemplary embodiment of the present application, shown in a cartridged condition;

FIG. 13A is a half-longitudinal cross-sectional view of the fitting nut and ferrule of FIG. 13, shown assembled with a fitting body;

FIG. 14 is a longitudinal cross-sectional view of a fitting nut and ferrule in accordance with another exemplary embodiment of the present application, shown prior to cartridging preassembly;

FIG. 14A is a longitudinal cross-sectional view of the fitting nut and ferrule of FIG. 14, shown in a cartridged condition;

FIG. 14B is a longitudinal cross-sectional view of the fitting nut and ferrule of FIG. 14, shown assembled with a fitting body;

FIG. 15 is a longitudinal cross-sectional view of a fitting nut and ferrule in accordance with another exemplary embodiment of the present application, shown in a cartridged condition;

FIG. 15A is a longitudinal cross-sectional view of the fitting nut and ferrule of FIG. 15, shown assembled with a fitting body;

FIG. 16 is a longitudinal cross-sectional view of a fitting nut and ferrule in accordance with another exemplary embodiment of the present application, shown in a cartridged condition;

FIG. 17 is a longitudinal cross-sectional view of a fitting nut and ferrule in accordance with another exemplary embodiment of the present application, shown in a cartridged condition;

FIG. 18 is a longitudinal cross-sectional view of a fitting nut and ferrule in accordance with another exemplary embodiment of the present application, shown prior to cartridging preassembly;

FIG. 18A is a longitudinal cross-sectional view of a fitting nut and ferrule in accordance with another exemplary embodiment of the present application, shown in a cartridged condition;

FIG. 19 is a longitudinal cross-sectional view of a fitting nut and ferrule in accordance with another exemplary embodiment of the present application, shown in a cartridged condition;

FIG. 20 is a longitudinal cross-sectional view of a fitting nut and ferrule in accordance with another exemplary embodiment of the present application, shown in a cartridged condition;

FIG. 21 is a longitudinal cross-sectional view of a fitting nut and ferrule in accordance with another exemplary embodiment of the present application, shown in a cartridged condition;

FIG. 22 is a longitudinal cross-sectional view of a fitting assembly in accordance with another exemplary embodiment of the present application;

FIG. 22A is an enlarged view of the circled region of FIG. 22 labeled 22A; and

FIG. 23 is a longitudinal cross-sectional view of a fitting nut and ferrules in accordance with another exemplary embodiment of the present application.

### DESCRIPTION OF THE EXEMPLARY EMBODIMENTS

Although the exemplary embodiments herein are presented in the context of a stainless steel tube fitting, the inventions herein are not limited to such applications, and will find use with many different conduits such as tube and pipe as well as different materials other than 316 stainless steel, including metals (e.g., brass, steel, nickel alloys) and non-metals for either the conduit, the gripping devices or the fitting components or any combination thereof. The inventions may also be used for liquid or gas fluid systems. While the inventions herein are illustrated with respect to particular designs of the conduit gripping devices and fitting components, the inventions are not limited to use with such designs, and will find application in many different fitting designs that use one or more conduit gripping devices. We use the term “conventional” to refer to commercially available or later developed parts or parts that are otherwise commonly known, used or that those of ordinary skill in the art would be familiar with in general, as distinguished from parts that may be modified in accordance with teachings herein. The inventions may be used with tube or pipe, so we use the term “conduit” to include tube or pipe or both. We generally use the term “fitting assembly” or “fitting” interchangeably as a shorthand reference to an assembly of typically first and second fitting components along with one or more conduit gripping devices. The concept of a “fitting assembly” thus may include assembly of the parts onto a conduit, either in a finger-tight position, a partial pull-up position or complete pull-up position; but the term “fitting assembly” is also intended to include an assembly of parts together without a conduit, for example for shipping or handling, as well as the constituent parts themselves even if not assembled together.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present application may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

Note that in the drawings herein, the fittings or fitting components are illustrated in longitudinal or half-longitudinal cross-section, it being understood by those skilled in the art that the fitting components are in practice annular parts about a longitudinal centerline axis or central axis X. All references herein to “radial” and “axial” are referenced to this central axis except as otherwise noted. In the illustrated embodiments herein, the ferrules are circumferentially uniform, or rotationally symmetrical about the central axis. In other embodiments, ferrules including one or more of the inventive features described herein may be circumferentially discontinuous, for example, including one or more longitudinal splits, ribs, or grooves around the circumference of the ferrule.

Fittings typically include two fitting components that are joined together (often a threaded fitting body and nut), and one or more gripping devices (often a ferrule or ferrules), however, the inventions herein may be used with fittings that include additional components. For example, a union fitting may include a body and two nuts. We also use the term “fitting remake” and derivative terms herein to refer to a fitting assembly that has been at least once tightened or completely pulled-up, loosened, and then re-tightened to another completely pulled-up position. Remakes may be done with the same fitting assembly parts (e.g. nut, body, ferrules), for example, or may involve the replacement of one of more of the parts of the fitting assembly. Reference herein to “outboard” (or axially outward) and “inboard” (or axially inward) are for convenience and simply refer to whether a direction is towards the center of a fitting (inboard or axially inward) or away from the center (outboard or axially outward). In the drawings, various gaps and spaces between parts (for example, gaps between the ferrules and the conduit in a finger-tight position) may be somewhat exaggerated for clarity or due to scale of the drawings.

A fitting body and nut (or other such fitting components) are typically provided with a pull-up mechanism for causing the gripping device to be installed on a conduit end so as to grip the conduit end and provide a seal against leakage. The term “pull-up” simply refers to the operation of tightening the tube fitting assembly so as to complete the assembly of the fitting onto the tube end with the desired tube grip and seal. In other embodiments contemplated by the present application, a compression fitting may include first and second fitting components that are pressed together, clamped, or otherwise installed for compression of a ferrule by installation of the first and second fitting components on a conduit end, and/or fitting components that are designed to be installed only once, without remakes.

Usually a metal tube fitting is first assembled in a “finger tight” condition and then a wrench or other suitable tool is used to tighten or “pull up” the fitting to its final initial and complete assembled condition. In some cases, especially for larger tube sizes, a swaging tool is used to pre-install a ferrule onto the tubing. The pull up mechanism most commonly used is a threaded connection of a female threaded nut component and a male threaded body component, with the tube gripping device being acted upon by these two components as they are threaded and tightened together. The body includes a tube end receiving bore with an angled body camming surface at the outer portion of that bore. The most commonly used camming surfaces are frusto-conical such that the term “camming angle” refers to the cone angle of the camming surface relative to the tube end longitudinal axis or outer surface. The tube end is axially inserted into the body bore and extends past the frusto-conical camming surface. The gripping device is slipped onto the tube end and the nut is partially threaded onto the body to the finger tight position such that the tube gripping device captured axially between the camming surface and the nut. The nut typically includes an inward shoulder having a drive surface that drives the tube gripping device into engagement with the angled camming surface on the body as the nut and body components are threadably tightened together. The angled camming surface imparts a radial compression to the tube gripping device, forcing the tube gripping device into a gripping engagement with the tube end. The compressed tube gripping device typically forms a seal against the outer surface of the tubing and also against the angled camming surface.

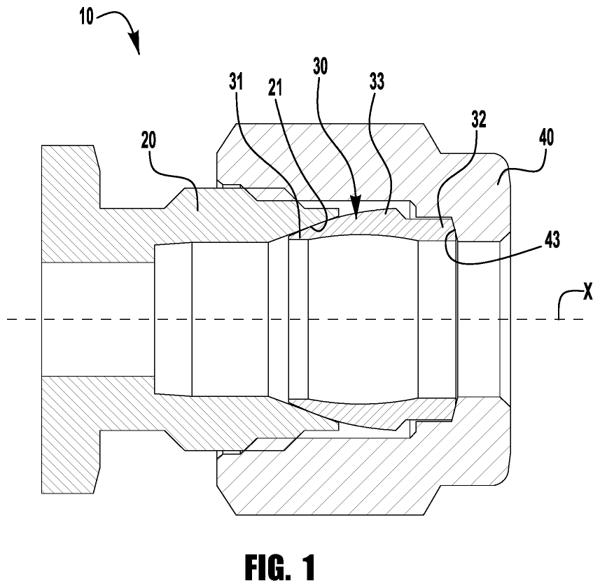

A single ferrule tube fitting, as the name implies, uses a single ferrule to accomplish both the tube grip and seal functions. For many conventional single ferrule tube fittings 10, as shown in FIG. 1, a biting action (as achieved by the front ferrule in a conventional two ferrule design) is accomplished by having the single ferrule 30 bow in a radially outward direction from the tube wall in the central region 33 or mid-portion of the single ferrule body between the front and back ends 31, 32 thereof. During pull-up of such a single ferrule fitting, the front end 31 of the ferrule 30 is driven against the angled camming surface 21 of the body 20 by the nut 40 pushing against the back end 32 of the ferrule 30. This bowing action helps direct the front end 31 of the single ferrule 30 into the tube end (not shown), and also causes the back end 32 of the single ferrule 30 to likewise engage the tube end. This is commonly accomplished by providing an angled drive surface 43 on the nut shoulder that engages the back end of the single ferrule so as to radially compress the back end 32 of the ferrule 30 into the tube end. In some such single ferrule designs (referred to herein as “bowing” single ferrules), the back end of the ferrule produces a circumferential line-contact depression in the tube end. This back end indentation is sometimes used with the single ferrule in order to attempt to improve the tube fitting's performance under vibration because the back end indentation may isolate outboard-tube vibration from affecting the front end tube bite.

According to an aspect of the present application, a fitting may be provided with a retaining structure by which a single ferrule is retained with a retaining fitting component, as a cartridge subassembly, at least prior to assembly of the fitting component with a mating fitting component, for example, to simplify inventory control and reduce final assembly time, to shroud and protect the ferrule surfaces from damaging impacts prior to field installation, and/or to prevent omission or improper installation (e.g., backwards installation or improper mixing of fitting parts) in the field. By “cartridge” we mean a group of parts retained together as a discontinuous unit, subassembly or preassembly. We therefore use the terms cartridge, unit, subassembly and preassembly synonymously herein in the context of a discontinuous structure. We also use the term “cartridge nut” or “conduit fitting cartridge” herein to refer to such a cartridge, unit or subassembly in which one or more conduit gripping devices are retained with a fitting component such as a female nut, for example. Therefore, the exemplary embodiments herein may be referred to as a cartridge nut design, however in alternative embodiments, a “cartridge nut” may include a male threaded cartridge nut design or a cartridge body design. Exemplary cartridge nut arrangements are described in co-owned U.S. Pat. No. 8,931,810 (the “'810 patent”), U.S. patent application Ser. No. 15/248,288, filed on Aug. 26, 2016 and titled COMPONENT RETAINING STRUCTURE FOR CONDUIT FITTING (the “'288 application”), U.S. patent application Ser. No. 15/416,048, filed on Jan. 26, 2017 and titled COMPONENT RETAINING STRUCTURE FOR CONDUIT FITTING (the “'048 application”), U.S. patent application Ser. No. 15/441,694, filed on Feb. 24, 2017 and titled COMPONENT RETAINING STRUCTURE FOR CONDUIT FITTING (the “'694 application”), and U.S. Provisional Patent Application Ser. No. 62/540,635, filed on Aug. 3, 2017 and titled COMPONENT RETAINING STRUCTURE FOR CONDUIT FITTING (the “'635 application”), the entire disclosures of each of which are incorporated herein by reference.

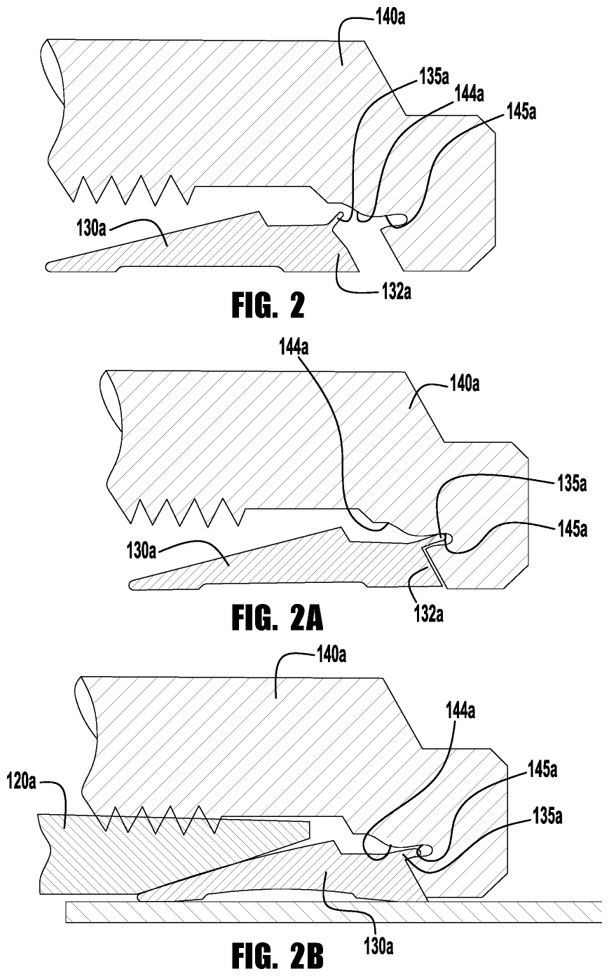

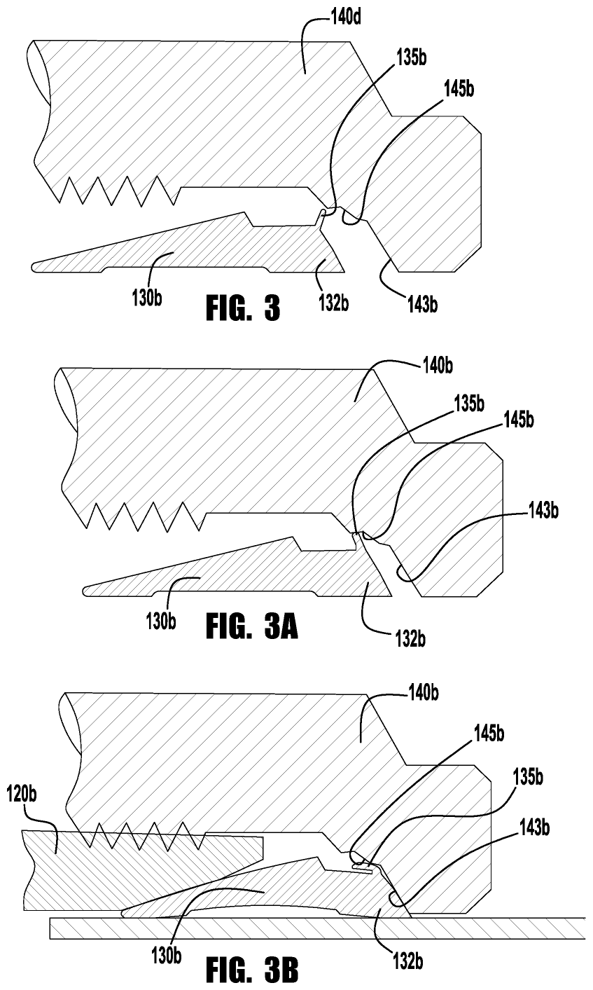

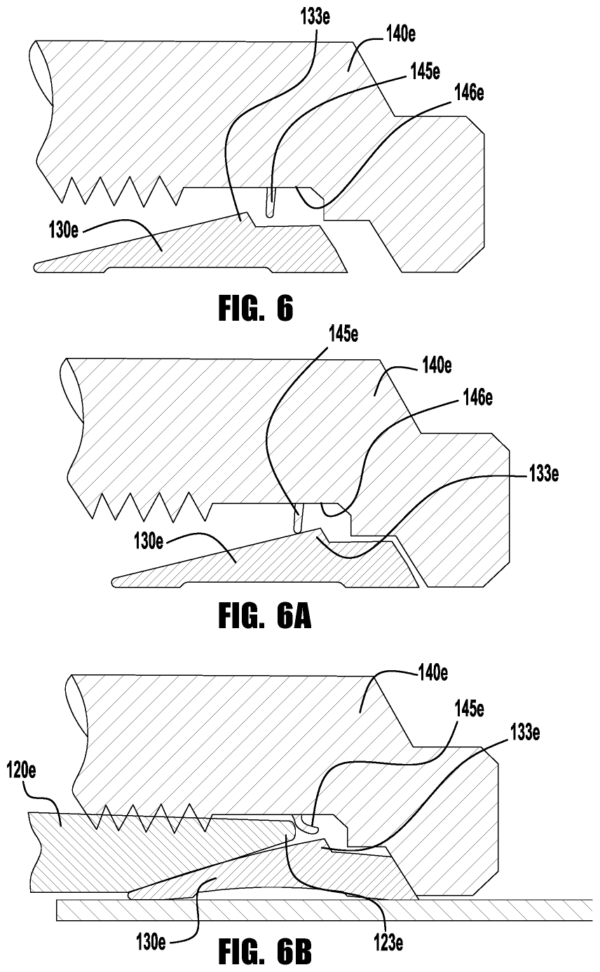

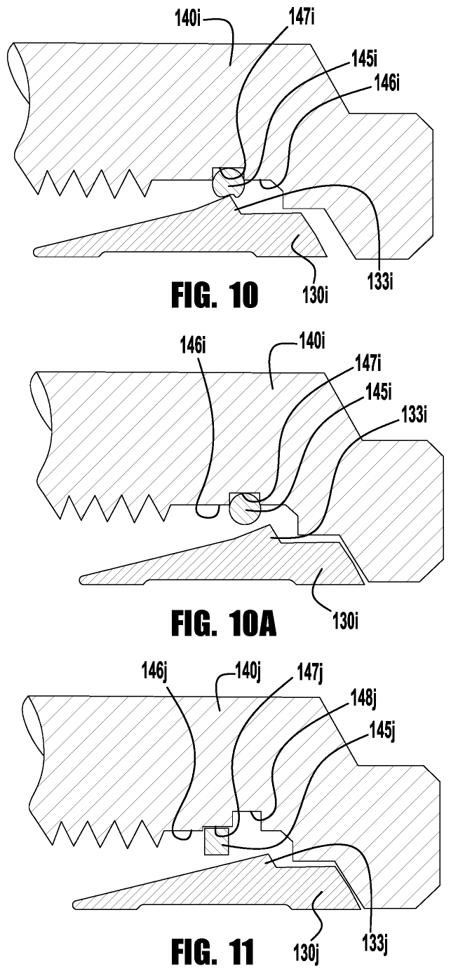

In a cartridge preassembly of a two-ferrule fitting, such as, for example, many of the exemplary cartridge preassembly embodiments of the above incorporated '810 patent, '288 application, '048 application, '694 application, and '635 application, the relative axial movement of the cartridging front ferrule with respect to the nut, due to compression of the rear ferrule, provides for deformation of the retaining feature (e.g., bending ferrule tab, internal nut projection, etc.) for release of the front ferrule. In a single ferrule fitting, the relative axial movement of the ferrule with respect to the nut, which directly drives the ferrule, is minimal, such that this relative axial movement may not generally be relied upon to provide for releasing deformation of a retaining feature. According to various aspects of the present application, a retained single ferrule may be released by any one or more of radial compression of the ferrule rear end during pull-up (see, e.g., the embodiments of FIGS. 2 and 13), deformation of the retaining feature by an end portion of the fitting body (see, e.g., the embodiments of FIGS. 6, 9, and 11), and cartridge retention of the ferrule at a position axially spaced from the nut drive surface, such that fitting pull-up include initial axial movement of the ferrule towards engagement with the nut drive surface to release the ferrule (see, e.g., the embodiments of FIGS. 3, 4, 5, 7, 8, and 12). In still other embodiments (see, e.g., the embodiment of FIG. 10), the ferrule may remain in a soft or lightly cartridged condition even after pull-up, such that the nut may be disengaged from the ferrule when the nut is loosened from the body.

FIGS. 2-21 illustrate exemplary embodiments of a fitting nut 140a-m, 240a-h and single ferrule 130a-m, 230a-h configured for cartridge retention as a subassembly or preassembly prior to assembly with a fitting body.

In some exemplary embodiments, a radially outer portion (e.g., a tab or flange) of the single ferrule (e.g., integral with or attached to the ferrule) engages a retaining feature of the retaining fitting component or nut to retain the ferrule with the nut as a cartridge subassembly or preassembly. In some such embodiments, the preassembly may be configured such that the outer portion of the ferrule disengages from the retaining feature upon pull-up (e.g., full or partial pull-up), for example, to permit withdrawal or removal of the ferrule from the retaining fitting nut upon fitting disassembly. In other embodiments, the ferrule may remain in retained engagement with the nut upon pull-up. In still other embodiments, the ferrule may remain in “soft” or “light” engagement with the nut upon pull-up, such that the nut may disengage from the ferrule when the nut is disassembled from the mating fitting body.

FIGS. 2, 2A, and 2B illustrate an exemplary ferrule 130a and nut 140a adapted for cartridge retention as a preassembly. The ferrule 130a includes a retaining tab or projection 135a extending axially and radially outward from a rear portion 132a of the ferrule. The nut 140a includes a recess 145a extending axially outward from the nut drive surface 143a. When the ferrule 130a is inserted into the nut 140a, the projection 135a engages a tapered interior surface 144a of the nut, which bends the projection 135a radially inward and axially outward to permit insertion of the projection into the recess 145a (FIG. 2A). The radially inward bending may be at least partially elastic, such that the projection 135a is outwardly biased against the recess 145a, for cartridge retention of the ferrule 130a with the nut 140a. When the nut 140a is assembled with a fitting body 120a (e.g., fully or partially pulled up), as shown in FIG. 2B, the ferrule 130a may be bowed to compress or constrict the ferrule rear portion 132a and projection 135a radially inward, thereby releasing the ferrule from cartridge engagement with the nut by allowing the projection to be axially withdrawn from the recess 145a when the nut 130a is disassembled from the body 120a.

FIGS. 3, 3A, and 3B illustrate another exemplary ferrule 130b and nut 140b adapted for cartridge retention as a preassembly. The ferrule 130b includes a retaining tab or projection 135b extending radially outward from a rear portion 132b of the ferrule. The nut 140b includes a tapered interior surface 145b extending axially inward of the nut drive surface 143b. When the ferrule 130b is inserted into the nut 140b, the projection 135b engages the tapered interior surface 145b of the nut, which bends the projection 135b radially and axially inward (FIG. 3A). The radially inward bending may be at least partially elastic, such that the projection 135b is outwardly biased against the tapered surface 145b, for cartridge retention of the ferrule 130b with the nut 140b, and axially spaced from the nut drive surface. When the nut 140b is assembled with a fitting body 120b (e.g., fully or partially pulled up) and the ferrule 130b is axially advanced toward the nut drive surface, as shown in FIG. 3B, the ferrule projection 135b engages a stepped portion 144b of the nut 140b, between the tapered surface 145b and the drive surface 143b, and is plastically bent further radially and axially inward, thereby releasing the ferrule 130b from cartridge engagement with the nut when the nut 130b is disassembled from the body 120b. Additionally or alternatively, radially inward compression of the ferrule rear portion 132b (e.g., due to bowing of the ferrule) during fitting pull-up may facilitate disengagement of the projection 135b from the tapered surface 145b for release of the ferrule 130b during fitting disassembly.

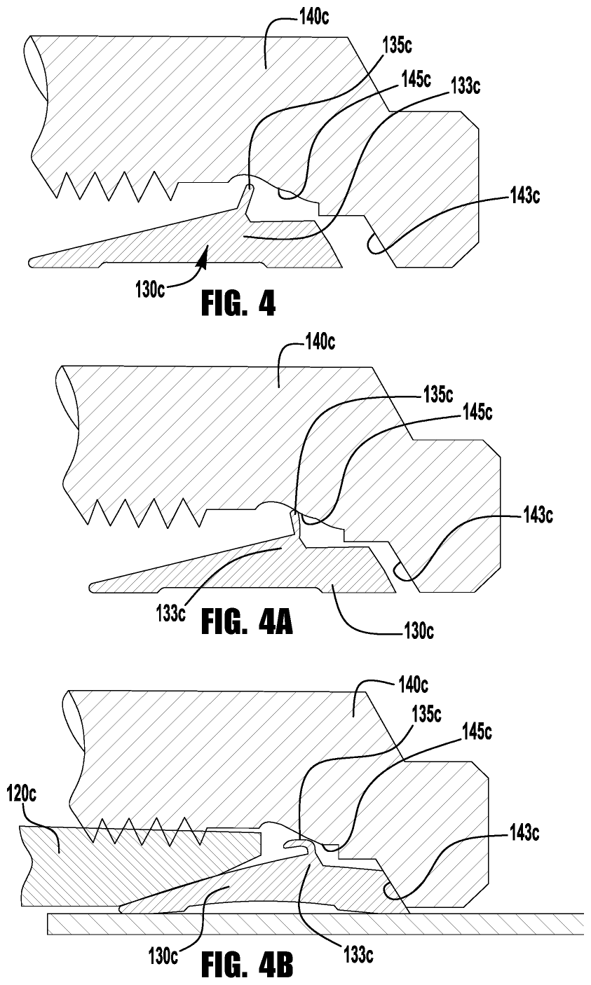

FIGS. 4, 4A, and 4B illustrate another exemplary ferrule 130c and nut 140c adapted for cartridge retention as a preassembly. The ferrule 130c includes a retaining tab or projection 135c extending radially outward from a central (e.g., outwardly bowing) portion 133c of the ferrule. The nut 140c includes a tapered interior surface 145c extending axially inward of the nut drive surface 143c. When the ferrule 130c is inserted into the nut 140c, the projection 135c engages the tapered interior surface 145c of the nut, which bends the projection 135c radially and axially inward (FIG. 4A). The radially inward bending may be at least partially elastic, such that the projection 135c is outwardly biased against the tapered surface 145c, for cartridge retention of the ferrule 130c with the nut 140c, and axially spaced from the nut drive surface. When the nut 140c is assembled with a fitting body 120c (e.g., fully or partially pulled up) and the ferrule 130c is axially advanced toward the nut drive surface, as shown in FIG. 4B, the central portion 133c of the ferrule 130c may bow radially outward, plastically compressing or crushing the projection 135c against the tapered interior surface 145c, thereby releasing the ferrule from cartridge engagement with the nut when the nut 130c is disassembled from the body 120c.

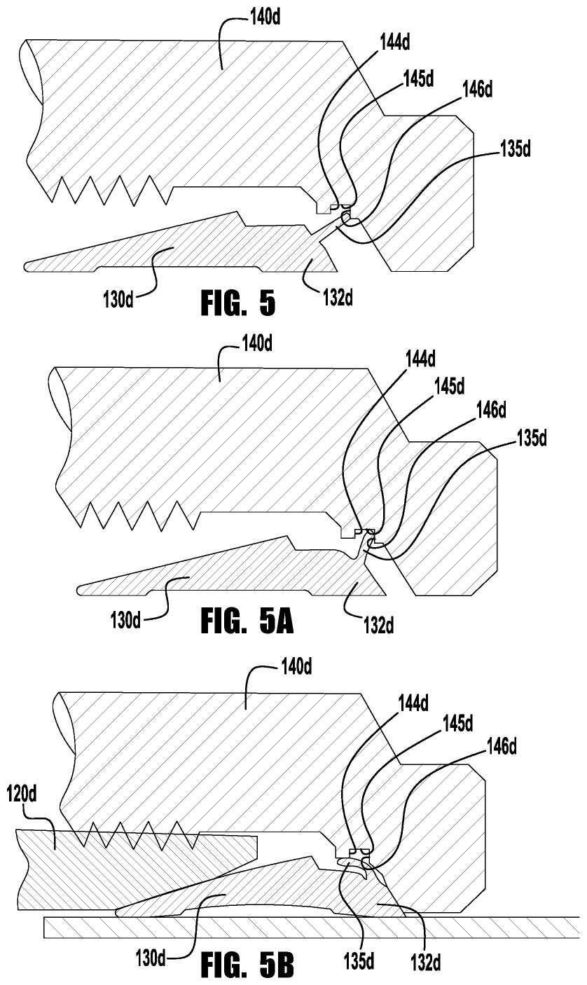

FIGS. 5, 5A, and 5B illustrate another exemplary ferrule 130d and nut 140d adapted for cartridge retention as a preassembly. The ferrule 130d includes a retaining tab or projection 135d extending axially and radially outward from a rear portion 132d of the ferrule, such that the projection of the loosely inserted ferrule (FIG. 5) is loosely received in axial alignment with a retaining recess 145d in the fitting nut 140d. To cartridge the ferrule 130d with the nut 140d, the retaining fitting component includes an inward facing, outboard radial wall 146d that defines an outer end of the recess and extends radially inward into alignment with the end portion 136d of the projection 135d. When an axial outward force is applied to the ferrule 135d to engage the projection end portion 136d with the outboard radial wall 146d, the projection is bent or pivoted axially inward and radially outward to a position in which the projection end portion radially aligns with an inboard radial wall 144d defining an inner end of the recess 145d, such that the outward bent projection is axially captured in the recess between the inboard radial wall and the outboard radial wall, with the ferrule 130d axially spaced from the nut drive surface. When the nut 140d is assembled with a fitting body 120d (e.g., fully or partially pulled up) and the ferrule 130d is axially advanced toward the nut drive surface, as shown in FIG. 5B, the ferrule projection 135d is bent further axially inward, and radially inward of the inboard radial wall 144d, such that the ferrule 130d may be withdrawn from the nut 140d when the nut is disassembled from the body 120d. Additionally or alternatively, radially inward compression of the ferrule rear portion (e.g., due to bowing of the ferrule) during fitting pull-up may facilitate disengagement of the projection 135d from the nut recess 145d for release of the ferrule 130d during fitting disassembly.

In other exemplary embodiments, a radially inner portion (e.g., a tab, flange, ring, or other retaining portion) of the nut (e.g., integral with or assembled with the nut) engages a portion of the ferrule to retain the ferrule with the nut as a cartridge subassembly or preassembly. In some such embodiments, the preassembly may be configured such that the engaged portion of the ferrule disengages from the retaining portion of the nut upon pull-up (e.g., full or partial pull-up), for example, to permit withdrawal or removal of the ferrule from the retaining fitting nut upon fitting disassembly. In other embodiments, the ferrule may remain in retained engagement with the nut upon pull-up. In still other embodiments, the ferrule may remain in “soft” or “light” engagement with the nut upon pull-up, such that the nut may disengage from the ferrule when the nut is disassembled from the mating fitting body.

As one example, a fitting nut may be provided with a bendable retaining projection for engaging and retaining the ferrule. FIGS. 6, 6A, and 6B illustrate an exemplary ferrule 130e and nut 140e adapted for cartridge retention as a preassembly. The nut 140e includes a retaining tab or projection 145e, which may be integral with or assembled with the nut, extending radially inward from an interior surface 146e of the nut. When the ferrule 130e is inserted into the nut 140e, an outer central portion 133e of the ferrule 130e engages the projection 145e, and bends the projection radially and axially outward to permit insertion of the ferrule central portion past the projection 145e (FIG. 6A). The radially outward bending may be at least partially elastic, such that the projection 145e snaps back into radial alignment with the ferrule central portion 133e, for cartridge retention of the ferrule 130e with the nut 140e. In other embodiments (not shown), the projection may be formed to initially extend axially inward, providing clearance for the inserted ferrule, and then staked or bent axially outward and radially inward to capture the inserted ferrule. In still other embodiments (not shown), the projection may be disposed on a washer, retaining ring, or other separate component that is installed in the nut (e.g., in a groove in the nut interior surface) after the ferrule is inserted, to capture the inserted ferrule.

When the nut 140e is assembled with a fitting body 120e (e.g., fully or partially pulled up), as shown in FIG. 6B, an end portion 123e of the body 120e may engage the projection to plastically bend the projection 145e radially and axially outward to disengage the projection from the ferrule central portion 133e, thereby releasing the ferrule from cartridge engagement with the nut to allow separation of the nut from the ferrule when the nut is disassembled from the body 120e.

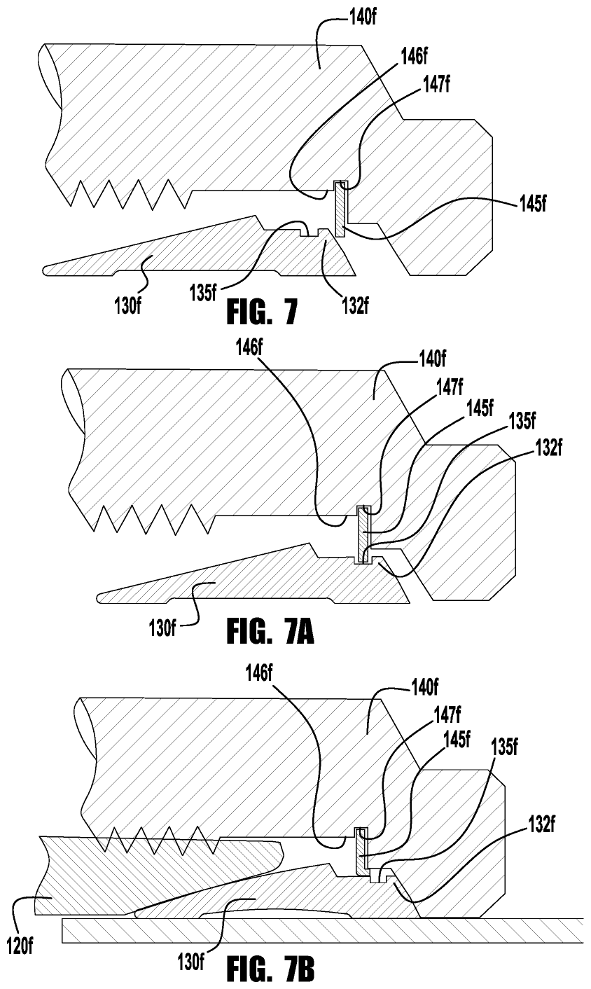

FIGS. 7, 7A, and 7B illustrate an exemplary ferrule 130f and nut 140f adapted for cartridge retention as a preassembly. The nut 140f includes a retaining tab or projection 145f, which may be integral with or assembled with the nut (as shown, a retaining ring 145f retained in an annular groove 147f in the nut), extending radially inward from an interior surface 146f of the nut. When the ferrule 130f is inserted into the nut 140f, an outer rear portion 132f of the ferrule 130f engages the projection 145f, and bends the projection radially and axially outward for axial alignment of the projection 145f with an annular recess 135f in the ferrule 130f. The radially inward bending may be at least partially elastic, such that the projection 145f snaps into the recess 135f for cartridge retention of the ferrule 130f with the nut 140f, and axially spaced from the nut drive surface (FIG. 7A). When the nut 140f is assembled with a fitting body 120f (e.g., fully or partially pulled up) and the ferrule 130f is axially advanced toward the nut drive surface, as shown in FIG. 7B, the rear portion 132f of the ferrule 130f may plastically bend the projection 145f further radially and axially outward to disengage the projection from the ferrule rear portion 132f, thereby releasing the ferrule from cartridge engagement with the nut to allow separation of the nut from the ferrule when the nut is disassembled from the body 120f. The projection may be notched or perforated to facilitate bending.

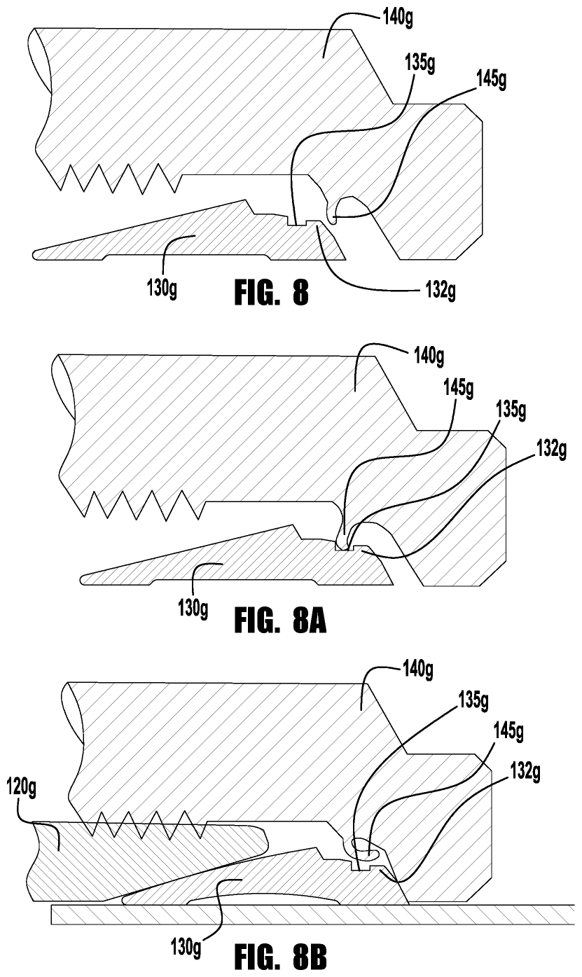

FIGS. 8, 8A, and 8B illustrate an exemplary ferrule 130g and nut 140g adapted for cartridge retention as a preassembly. The nut 140g includes a retaining tab or projection 145g, which may be integral with or assembled with the nut (as shown, integral with the nut), extending radially inward from an interior surface 146g of the nut. When the ferrule 130g is inserted into the nut 140g, an outer rear portion 132g of the ferrule 130g engages the projection 145g, and bends the projection radially and axially outward for axial alignment of the projection 145g with an annular recess 135g in the ferrule 130g. The radially inward bending may be at least partially elastic, such that the projection 145g snaps into the recess 135g for cartridge retention of the ferrule 130g with the nut 140g, and axially spaced from the nut drive surface (FIG. 8A). When the nut 140g is assembled with a fitting body 120g (e.g., fully or partially pulled up) and the ferrule 130g is axially advanced toward the nut drive surface, as shown in FIG. 8B, the rear portion 132g of the ferrule 130g may plastically bend the projection 145g further radially and axially outward to disengage the projection from the ferrule rear portion 132g, thereby releasing the ferrule from cartridge engagement with the nut to allow separation of the nut from the ferrule when the nut is disassembled from the body 120g. As shown, the projection 145g may include a narrowed hinge portion to facilitate bending.

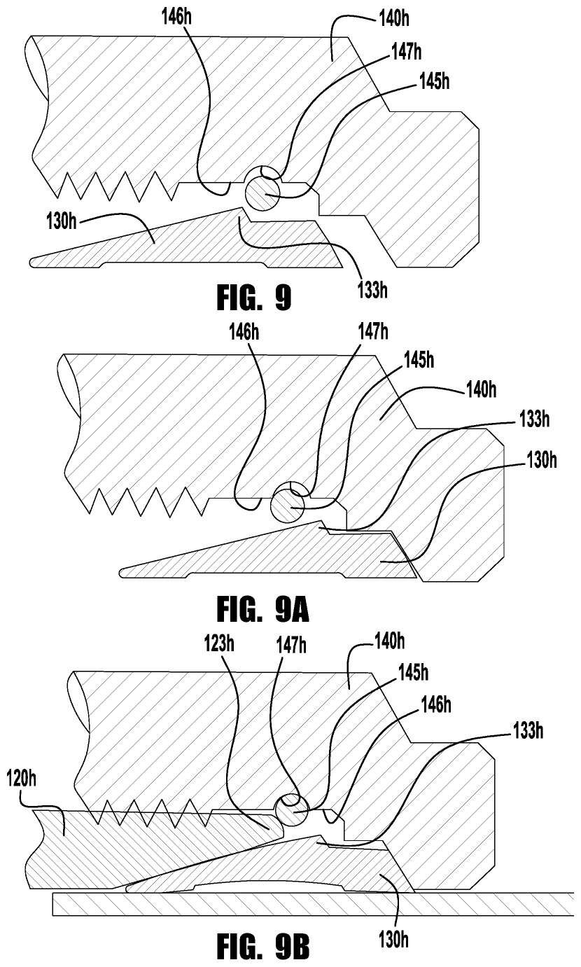

As another example, a fitting nut may be provided with a radially expandable retaining ring for engaging and retaining the ferrule. FIGS. 9, 9A, and 9B illustrate an exemplary ferrule 130h and nut 140h adapted for cartridge retention as a preassembly. The nut 140h includes a retaining ring 145h, retained in an annular recess or groove 147h in the nut 140h, and protruding radially inward from an interior surface 146h of the nut. When the ferrule 130h is inserted into the nut 140h, an outer central portion 133h of the ferrule 130h engages the ring 145h, and expands the ring radially outward, and further into the groove 147h, to permit insertion of the ferrule central portion past the ring 145h (FIG. 9A). The radially expansion of the ring may be at least partially elastic, such that the ring 145h snaps back into radial alignment with the ferrule central portion 133h, for cartridge retention of the ferrule 130h with the nut 140h. When the nut 140h is assembled with a fitting body 120h (e.g., fully or partially pulled up), as shown in FIG. 9B, an end portion 123h of the body 120h may engage the ring to plastically or permanently expand the ring 145h radially outward (e.g., by press fit engagement of the ring 145h further in the groove 147h) to disengage the ring from the ferrule central portion 133h, thereby releasing the ferrule from cartridge engagement with the nut to allow separation of the nut from the ferrule when the nut is disassembled from the body 120h. In other embodiments, the ring may provide “soft” or “light” retention of the ferrule 130h in the pulled-up fitting, with disassembly of the nut 140h from the body 120h causing the ferrule central portion 133h to expand the ring 145h and permit withdrawal of the ferrule from the nut.

FIGS. 10 and 10A illustrate an exemplary ferrule 130i and nut 140i adapted for cartridge retention as a preassembly. The nut 140i includes a compressible retaining ring 145i, (e.g., formed from a compressible material, such as, for example, an elastomer or plastic), retained in an annular recess or groove 147i in the nut 140i, and protruding radially inward from an interior surface 146i of the nut. When the ferrule 130i is inserted into the nut 140i, an outer central portion 133i of the ferrule 130i engages the ring 145i, and outwardly compresses or expands the ring to permit insertion of the ferrule central portion past the ring 145i (FIG. 10A). The expansion of the ring may be at least partially elastic, such that the ring 145i snaps back into radial alignment with the ferrule central portion 133i, for cartridge retention of the ferrule 130i with the nut 140i. The ring 145i may provide “soft” or “light” retention of the ferrule 130i in the pulled-up fitting, with disassembly of the nut 140i from the body 120i causing the ferrule central portion 133i to expand the ring 145i and permit withdrawal of the ferrule from the nut.

As another example, a fitting nut may be provided with an axially movable retaining ring for engaging and retaining the ferrule. FIGS. 11 and 11A illustrate an exemplary ferrule 130j and nut 140j adapted for cartridge retention as a preassembly. The nut 140j includes a retaining ring 145j that is retained in, and radially biased outward against, a first recessed portion 147j of the nut, and protruding radially inward from an interior surface 146j of the nut, and into radial alignment with an outer central portion 133j of the ferrule 130j, to retain the ferrule 130j in the nut 140j as a preassembly. To prepare the preassembly, the ferrule 130j may first be loosely installed in the nut 140j, and the retaining ring 145j may then be installed in the first recessed portion 147j. When the nut 140j is assembled with a fitting body 120j (e.g., fully or partially pulled up), as shown in FIG. 11A, an end portion 123j of the body 120j may engage the ring 145j to axially move the ring into axial alignment with a second recessed portion 148j of the nut, recessed from the first recessed portion, causing the ring 145h to snap or expand radially outward into the second recessed portion 148j, to radially separate from the ferrule central portion 133j, thereby releasing the ferrule from cartridge engagement with the nut to allow separation of the nut from the ferrule when the nut is disassembled from the body 120j.

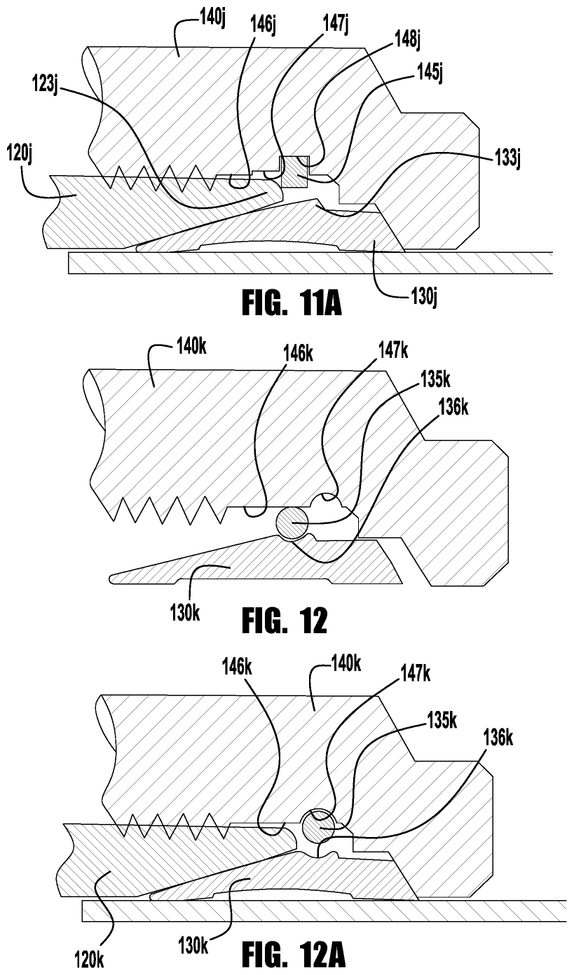

FIGS. 12 and 12A illustrate an exemplary ferrule 130k and nut 140k adapted for cartridge retention as a preassembly. A retaining ring 135k is retained in a groove 136k in the ferrule 130k, and is radially biased outward against an interior surface 146k of the nut, to retain the ferrule 130k in the nut 140k as a preassembly. To prepare the preassembly, the ferrule 130k may first be loosely installed in the nut 140k, axially spaced from the nut drive surface, and the retaining ring 145j may then be installed in the groove 136k, and wedged between the ferrule and the nut interior surface 146k. When the nut 140k is assembled with a fitting body 120k (e.g., fully or partially pulled up) and the ferrule 130k is axially advanced toward the nut drive surface, as shown in FIG. 12A, the ferrule 130k is axially advanced to align the retaining ring 135k with an annular recess 147k in the nut, allowing the outwardly biased retaining ring 135k to radially expand into the recess 147k and disengage from the ferrule 130k, thereby releasing the ferrule from cartridge engagement with the nut to allow separation of the nut from the ferrule when the nut is disassembled from the body 120k.

In still other embodiments, a temporary attachment may be provided between an outer rear portion of the ferrule and an axially aligned interior surface of the nut. When the fitting nut is assembled with a fitting body (e.g., fully or partially pulled up), radial compression of the ferrule rear portion causes the ferrule rear portion to detach from the interior surface of the nut, allowing separation of the nut from the ferrule when the nut is disassembled from the body. FIGS. 13 and 13A illustrate an exemplary ferrule 130m and nut 140m adapted for cartridge retention as a preassembly. An attachment element or releasable material 135m (e.g., spot weld, brazing, adhesive, hook and loop fasteners) is provided between the rear portion 132m and the nut interior surface 146m to retain the ferrule 130m in the nut 140m as a preassembly. When the nut 140m is assembled with a fitting body 120m (e.g., fully or partially pulled up), as shown in FIG. 13A, the ferrule 130m bows under axial compression, with the ferrule rear portion 132m being radially compressed to radially separate from the nut interior surface 146m at the attachment element 135m, allowing separation of the nut 140m from the ferrule 130m when the nut is disassembled from the body 120m.

While a bowing single ferrule may be adequate for some applications, the use of a back end tube grip actually works against the effort to grip the tube end at the front end of the single ferrule. Ideally, the single ferrule should be completely in three dimensional compression between the nut and the camming surface of the body. Providing a back end grip actually places a counter acting tension to the single ferrule that works against the front end compression being used to provide the tube grip. Additionally, the outward bowing action tends to work against the effort to grip the tube at the front end of the single ferrule because, in order to enable the outward bowing action, the single ferrule requires a lessened mass that is adjacent the tube gripping “bite.” As such, traditional bowing single ferrules are generally less efficient at transferring axial force to the ferrule bite since energy is lost in the radial action of bowing.

A single ferrule may be configured to provide an adequate front end grip and seal without compression of the ferrule back end against the tube end. In one such embodiment, a ferrule may include a first hinge portion axially inward of a first end portion of the ferrule and configured to hinge radially inward upon complete pull-up against a fitting body to collet the first hinge portion against the tube end, and a second hinge portion axially inward of a second end portion of the ferrule and configured to hinge radially inward upon pull-up against a fitting nut to maintain the second end portion in a radially uncompressed condition. While a central portion of the ferrule may bow radially outward during pull-up, the dual hinging portions of the ferrule limit this outward bowing action and maintain a compressed and colleting front portion of the ferrule.

According to an aspect of the present application, a dual hinging single ferrule may be configured to be functionally symmetrical or reversible within a fitting, for installation with either a first end portion or a second end portion engaging the camming surface of the first fitting component (e.g., fitting body), such that the body engaging end portion provides an adequate front end grip and seal without rear end compression of the other of the first and second end portions against the conduit end. As used herein, a “functionally symmetrical” ferrule may include a ferrule having features or elements that are not symmetrical about a plane that bisects an axial center point of the ferrule, but that do not affect the gripping, colleting, hinging or other such actions of the ferrule. These asymmetrical elements may be provided, for example, for tooling, machining, or marking purposes. In other embodiments, the ferrule may be fully symmetrical about a plane that bisects an axial center point of the ferrule. By providing a functionally symmetrical or reversible ferrule configuration, a “fool-proof” installation of the ferrule in a fitting may be offered, as the fitting would function properly with the ferrule installed in either direction. Exemplary embodiments of fittings with functionally symmetrical single ferrules are described in U.S. patent application Ser. No. 15/428,194, filed on Feb. 9, 2017 and entitled “FERRULE FOR A CONDUIT FITTING” (the “'194 application”), the entire disclosure of which is incorporated herein by reference.

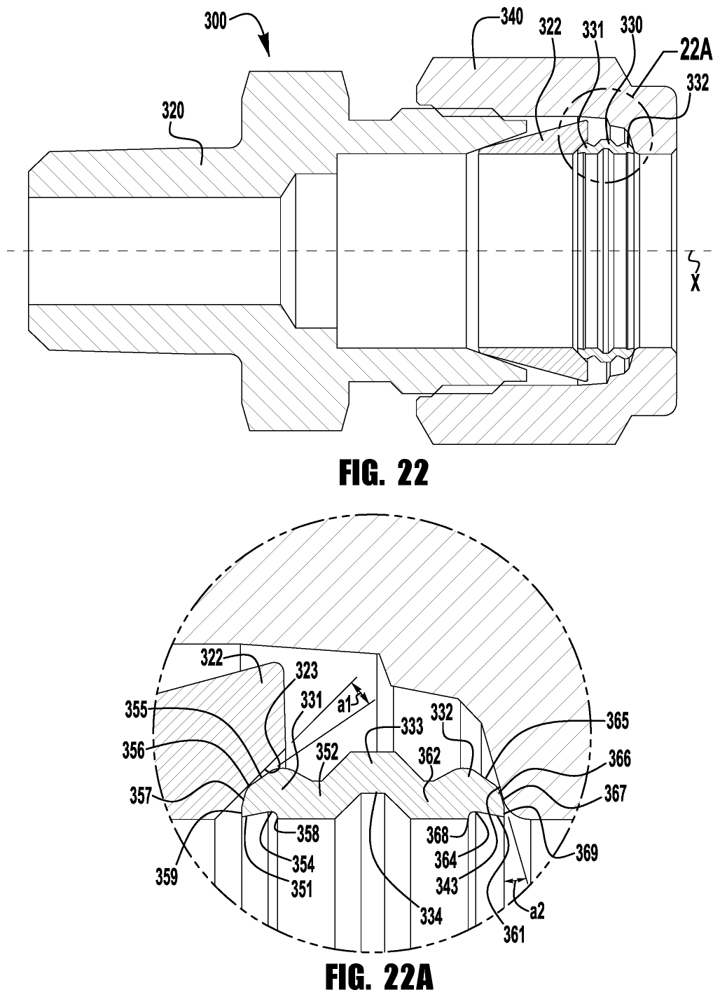

In exemplary embodiments of the present application, a fitting may be provided with a reversible single ferrule, which may be similar to one or more of the exemplary reversible ferrule embodiments of the above incorporated '194 application, and may be substantially the same as or similar to the rear ferrule 330 of FIGS. 22 and 22A, described in greater detail below, that is retained in a first fitting component (e.g., a fitting nut) as a subassembly at least prior to assembly of the fitting subassembly with a mating second fitting component (e.g., a fitting body). The ferrule may be retained in the fitting component using a variety of arrangements. As one example, a fitting including a reversible ferrule having an enlarged, radially extending central portion or central boss portion (configured, for example, to resist hinging deformation at this central portion and to concentrate hinging deformation at the narrowed hinge portions) may including a retaining fitting component (e.g., a fitting nut) having a retaining feature that engages the central boss portion to retain the ferrule in the retaining fitting component as a subassembly.

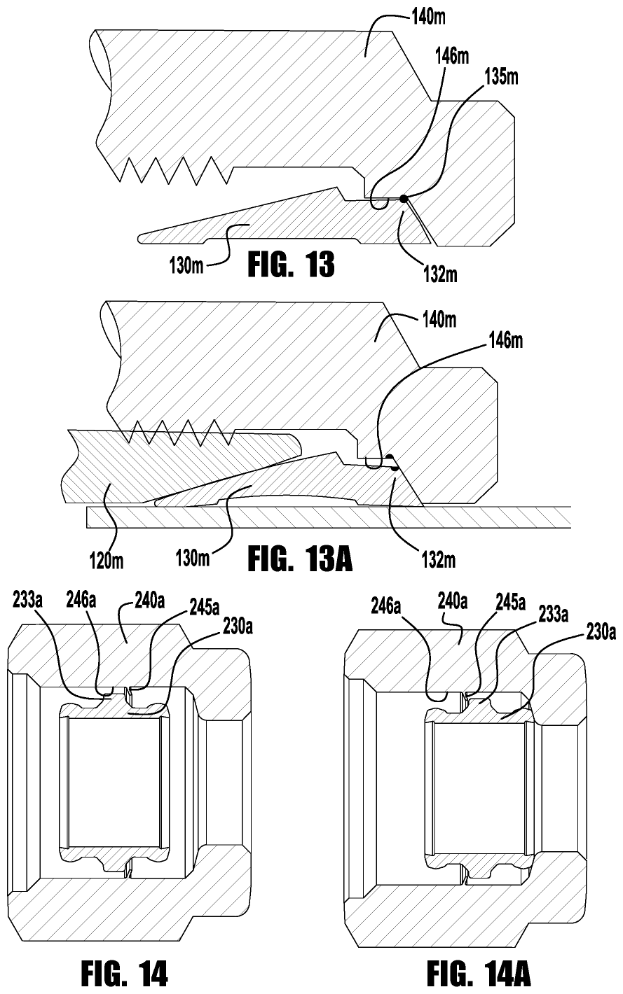

FIGS. 14, 14A, and 14B illustrate an exemplary reversible ferrule 230a and nut 240a adapted for cartridge retention as a preassembly. The nut 240a includes a retaining tab or projection 245a, which may be integral with or assembled with the nut, extending radially inward from an interior surface 246a of the nut. When the ferrule 230a is inserted into the nut 240a, a central boss portion 233a of the ferrule 230a engages the projection 245a, and bends the projection radially and axially outward to permit insertion of the ferrule central portion past the projection 245a (FIG. 14A). The radially outward bending may be at least partially elastic, such that the projection 245a snaps back into radial alignment with the ferrule central portion 233a, for cartridge retention of the ferrule 230a with the nut 240a. In other embodiments (not shown), the projection may be formed to initially extend axially inward, providing clearance for the inserted ferrule, and may then be staked or bent axially outward and radially inward (e.g., by an inserted tool) to capture the inserted ferrule. In still other embodiments (not shown), the projection may be disposed on a washer, retaining ring, or other separate component that is installed in the nut (e.g., in a groove in the nut interior surface) after the ferrule is inserted, to capture the inserted ferrule.

When the nut 240a is assembled with a fitting body 220a (e.g., fully or partially pulled up), as shown in FIG. 14B, an end portion 223a of the body 220a may engage the projection to plastically bend the projection 245a radially and axially outward to disengage the projection from the ferrule central boss portion 233b, thereby releasing the ferrule from cartridge engagement with the nut to allow separation of the nut from the ferrule when the nut is disassembled from the body 220b.

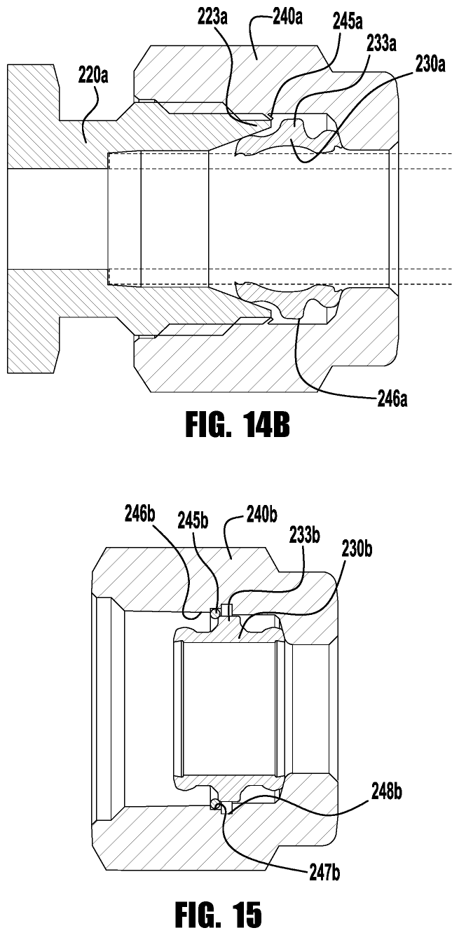

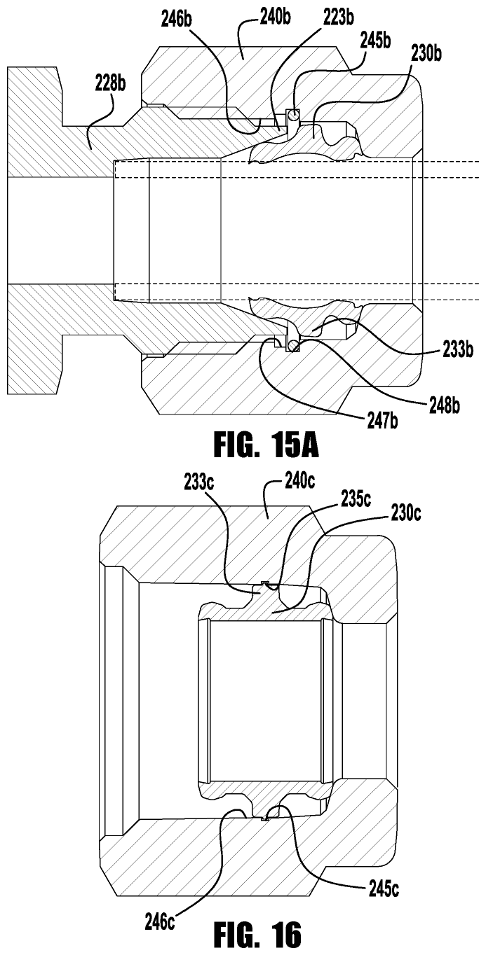

As another example, a fitting nut may be provided with an axially movable retaining ring for engaging and retaining the reversible ferrule. FIGS. 15 and 15A illustrate an exemplary reversible ferrule 230b and nut 240b adapted for cartridge retention as a preassembly. The nut 240b includes a retaining ring 245b that is retained in, and radially biased outward against, a first recessed portion 247b of the nut, and protruding radially inward from an interior surface 246b of the nut, and into radial alignment with a central boss portion 233b of the ferrule 230b, to retain the ferrule 230b in the nut 240b as a preassembly. To prepare the preassembly, the ferrule 230b may first be loosely installed in the nut 240b, and the retaining ring 245b may then be installed in the first recessed portion 247b. When the nut 240b is assembled with a fitting body 220b (e.g., fully or partially pulled up), as shown in FIG. 15A, an end portion 223b of the body 220b may engage the ring 245b to axially move the ring into axial alignment with a second recessed portion 248b of the nut, recessed from the first recessed portion 247b, causing the ring 245b to snap or expand radially outward into the second recessed portion 248b, to radially separate from the central boss portion 233b, thereby releasing the ferrule from cartridge engagement with the nut to allow separation of the nut from the ferrule when the nut is disassembled from the body 220b.

In other embodiments, a reversible single ferrule may be provided with a central boss portion having a detent feature for engaging a corresponding detent feature of the nut, for example, to provide soft or light cartridging of the ferrule in the nut. FIG. 16 illustrates an exemplary reversible ferrule 230c and nut 240c adapted for cartridge retention as a preassembly. The ferrule 230c includes a central boss portion 233c having a detent projection 235c that snaps into engagement with a corresponding groove 245c in the nut interior surface 246c when the ferrule 230c is installed in the nut. Detent engagement of the projection 235c and groove 245c may provide “soft” or “light” retention of the ferrule 230c even after pull-up of the fitting, with disassembly of the nut 240c from the body causing the ferrule projection 235c to disengage from the nut groove 245c. In other embodiments (not shown), the nut interior surface may be provided with a detent projection or rib, and the ferrule central boss may be provided with a corresponding groove, for similar soft or light cartridging of the ferrule in the nut.

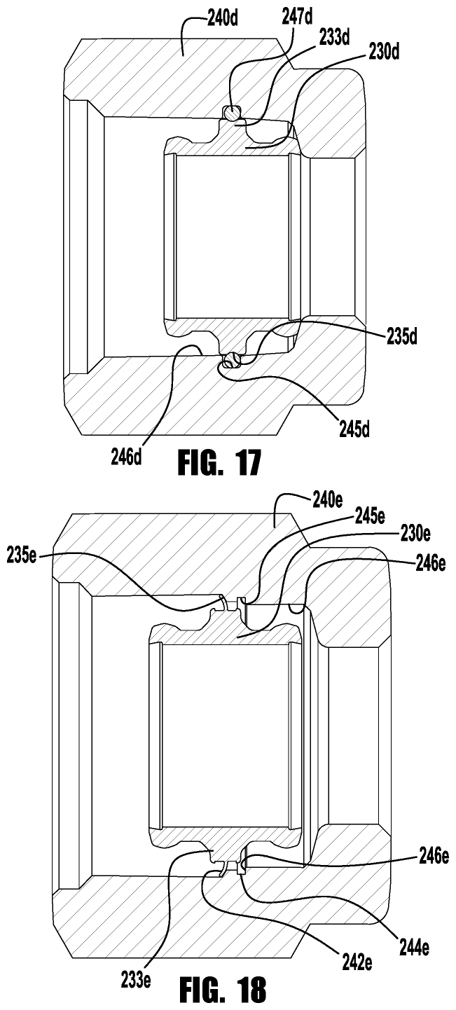

In other embodiments, a separate elastic or snap ring may provide soft or light cartridging of the reversible ferrule in the fitting nut. FIG. 17 illustrates an exemplary reversible ferrule 230d and nut 240d adapted for cartridge retention as a preassembly. The nut 240d includes an annular recess 245d in the interior surface 246d that retains a retaining ring 247d. The ferrule 230d includes a central boss portion 233d having a groove 235d that snaps into engagement with the retaining ring 247d when the ferrule 230d is installed in the nut 240d. Detent engagement of the retaining ring 247d and groove 235d may provide “soft” or “light” retention of the ferrule 230d even after pull-up of the fitting, with disassembly of the nut 240d from the body causing the ferrule groove 235d to disengage from the retaining ring 247d. In other embodiments (not shown), a retaining ring may be installed on the ferrule central boss portion (e.g., in an annular recess) for detent engagement with a corresponding groove in the nut interior surface, for similar soft or light cartridging of the ferrule in the nut.

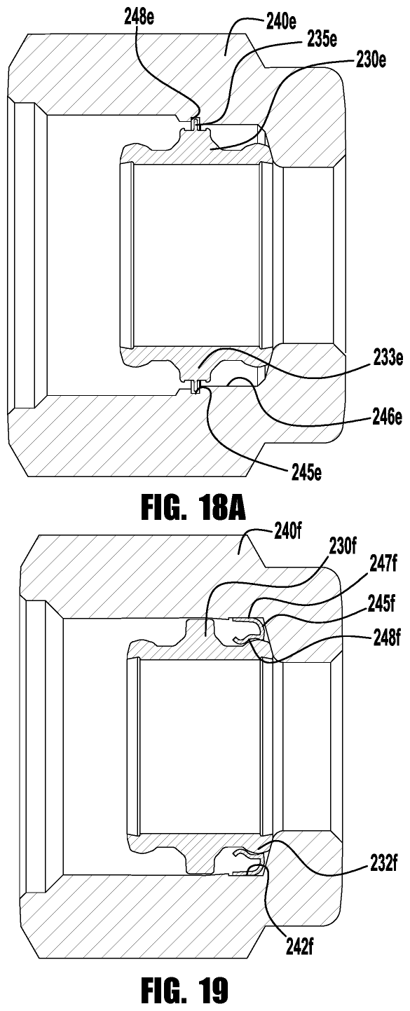

FIGS. 18 and 18A illustrate another exemplary reversible ferrule 230e and nut 240e adapted for cartridge retention as a preassembly. The ferrule 230e includes a retaining tab or projection 235e extending radially outward from a central boss portion 233e of the ferrule, and into an annular recess 245e in an interior surface 246e of the nut 240e for cartridge retention of the ferrule 230e with the nut 240e. The projection 235e may be interengaged with the recess 245e using a variety of suitable arrangements. As one example, the pre-cartridged projection may be bent axially inward against an internal step 242e in the nut interior surface 246e, elastically snapping into the recess 245e upon alignment with the recess. When the nut 240e is assembled with a fitting body (e.g., fully or partially pulled up), not shown, the ferrule projection 235e is bent axially inward against outboard radial wall 246e, and radially inward of the inboard radial wall 244e, such that the ferrule 230e may be withdrawn from the nut 240e when the nut is disassembled from the body. In such an embodiment (not shown), the ferrule may be cartridged in a position axially spaced from the nut drive surface, such that axial movement of the ferrule towards the drive surface during fitting assembly provides for this releasing deformation (similar to the embodiments of FIGS. 3, 4, 5, 7, 8, and 12).

In another exemplary, a fitting including a reversible ferrule having enlarged first and second end portions, similar to embodiments of the above incorporated '194 application, may including a retaining fitting component having a retaining feature that engages the axially outward enlarged end portion of the ferrule (i.e., the enlarged end portion of the reversible ferrule that faces the nut drive surface) to retain the ferrule in the retaining fitting component as a subassembly.

FIG. 19 illustrates another exemplary reversible ferrule 230f and nut 240f adapted for cartridge retention as a preassembly. The nut 240f includes a retaining insert 245f having an outer radial portion 247f retained within a circumferential recess 242f in the interior wall 246f of the nut to axially capture the insert, and an inner radial portion 248f that extends radially inward and is shaped to engage an upper surface of the enlarged rear end portion 232f of the rear ferrule 230f. The retaining insert 245f may be compressible or otherwise flexible (e.g., a flexible split ring) to facilitate installation in the nut. The ferrule 230f may be installed in the nut 240f by pushing the rear end portion 232f of the ferrule against the inner radial portion 248f of the insert 245f to elastically radially expand the inner radial portion of the insert to receive the rear end portion 232f therethrough. When the nut 240f is assembled with a fitting body and is pulled up on the body (not shown), the rear end portion 232f of the ferrule 230f may hinge radially outward, as described in the above incorporated '194 application, to plastically expand the inner radial portion 248f of the insert 245f away from interlocking or interfering engagement with the ferrule rear end portion, thus allowing subsequent disassembly of the nut from the ferrules of the pulled up fitting. In some embodiments, the radially inner portion 248f of the insert may remain in at least partial radial interference with the ferrule rear portion (e.g., in soft or light cartridging engagement), while still allowing for nut and ferrule disassembly (e.g., by outward bending deformation of the inner radial portion of the insert as the nut is disassembled from the fitting body).

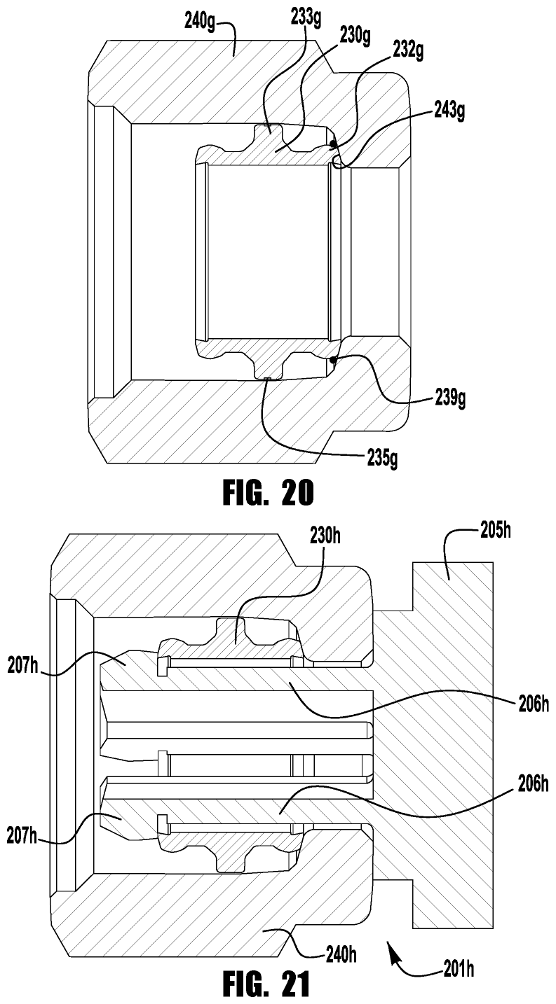

In still other embodiments, a temporary attachment may be provided between a ferrule and an aligned interior surface of the nut. FIG. 20 illustrates an exemplary reversible ferrule 230g and nut 240g adapted for cartridge retention as a preassembly. An attachment element or releasable material 235g (e.g., spot weld, brazing, adhesive, hook and loop fasteners) may be provided between the central boss portion 233g of the ferrule 240g and the interior surface 246g of the nut 240g. Additionally or alternatively, an attachment element or releasable material 239g (e.g., spot weld, brazing, adhesive, hook and loop fasteners) may be provided between the enlarged rear end portion 232g of the ferrule 240g and the drive surface 243g of the nut 240g. When the nut 240g is assembled with a fitting body (e.g., fully or partially pulled up), not shown, relative movement of the nut 240g with respect to the ferrule 230g causes the attached nut and ferrule surfaces to separate (e.g., by breaking or detaching the releasable material 235g, 239g), allowing separation of the nut 240g from the ferrule 230g when the nut is disassembled from the body.

In other embodiments, a nut and ferrule may be retained as a subassembly, prior to assembly with a fitting body, on a tool or arbor, examples of which are described in co-owned U.S. Pat. No. 7,497,483 (the “'483 patent”), the entire disclosure of which is incorporated herein by reference. FIG. 21 illustrates an exemplary embodiment using a tool or arbor 201h. In this embodiment, the tool 201h is sized so as to receive and retain a female threaded nut 240h and associated reversible single ferrule 230h, with flexible fingers 206h extending from a head portion 205h through the central openings of the nut 240h and ferrule 230h, and raised lips 207h engaging an outer edge of the ferrule 230h. The operation and use of the tool 201h may be as described in the above incorporated '483 patent. Use of the tool 201h allows the manufacturer to provide the end user with a nut and ferrule assembly with the ferrules and nut already combined properly in a single subassembly of parts for installation onto a tube end having an associated male threaded body (not shown).

As described in the above incorporated '194 Application and shown herein, to allow the ferrule to function as a reversible ferrule, installable in the fitting assembly with either of the first and second end portions engaging the fitting body and the other of the first and second end portions engaging the fitting nut, each of the first and second end portions is provided with both a camming surface and a driven surface. The first and second end camming surfaces are each contoured and positioned to engage the body camming surface when the ferrule is installed with the corresponding ferrule end portion facing the fitting body. The first and second end driven surfaces are each contoured and positioned to engage the nut drive surface when the ferrule is installed with the corresponding ferrule end portion facing the fitting nut. According to another aspect of the present application, a reversible ferrule (which may, but need not, be structurally similar to any one or more of the reversible single ferrules disclosed in the '194 application and described herein) may be provided as a rear ferrule in a two ferrule conduit fitting, such that in either installed orientation of the rear ferrule, a forward (i.e., front ferrule engaging) portion of the rear ferrule is compressed against the conduit upon fitting pull-up to perform a tube grip function, and a rear (i.e., nut drive surface engaging) portion remains free from gripping engagement with the conduit, for effective gripping of the conduit upon fitting pull-up.

FIG. 22 illustrates an exemplary two ferrule fitting 300 having a fitting body 320, fitting nut 340, front ferrule 322 and reversible rear ferrule 330. As shown, the rear ferrule 330 includes an interior wall extending between first and second end portions 331, 332 of the ferrule and along a central longitudinal axis X to receive the conduit end. To allow the rear ferrule 330 to function as a reversible ferrule, installable in the fitting assembly 300 with either of the first and second end portions 331, 332 engaging the fitting body 320 and the other of the first and second end portions engaging the fitting nut 340, as shown in the enlarged view of FIG. 22A, each of the first and second end portions 331, 332 is provided with both a camming surface 355, 365 and a driven surface 357, 367. The first and second end camming surfaces 355, 365 are each contoured and positioned to engage a rear camming surface 323 of the front ferrule 322 when the rear ferrule 330 is installed with the corresponding ferrule end portion 331, 332 facing the fitting body 320. The first and second end driven surfaces 357, 367 are each contoured and positioned to engage the nut drive surface 343 when the rear ferrule 330 is installed with the corresponding ferrule end portion 331, 332 facing the drive surface 343. For consistent, reversible functionality, the first and second camming surfaces 355, 365 may be disposed at substantially equal (e.g., within manufacturing tolerances), opposed angles with respect to the central axis X. Likewise, the first and second driven surface 357, 367 may be disposed at substantially equal, opposed angles with respect to the central axis X.

In the illustrated embodiment, the first and second end driven surfaces 357, 367 are disposed radially inward and axially outward of the corresponding camming surfaces 355, 365, with the driven surface defining the axially outermost or endmost surfaces of the ferrule 330. The driven surfaces 357, 367 are disposed at a steeper angle (e.g., between 70° and 90°, or approximately 85°) with respect to the ferrule central axis X, to further limit or prevent radial inward compression of the nut engaging end portion of the rear ferrule 330, and the camming surfaces 355, 365 are disposed at a shallower angle (e.g., between 0° and 65°, between 25° and 65°, or approximately 40°) with respect to the ferrule central axis, to radially compress the body engaging end portion of the ferrule against the conduit end C. In some embodiments, the angle of the camming surfaces 355, 365 may be selected at least in part based on the angle of the front ferrule camming surface, for example, to provide a desired difference angle between the front ferrule camming surface and the rear ferrule camming surface (e.g., about 5°). For example, in a fitting having a front ferrule with a steeper camming angle of about 45°, the camming surfaces 355, 365 may be disposed at an angle of about 40°, and in a fitting having a front ferrule with a shallower camming angle of about 20°, the camming surfaces 355, 365 may be disposed at a shallower angle of about 15°.

In the illustrated embodiment, the driven surfaces 357, 367 and camming surfaces 355, 365 are each substantially frustoconical, and the driven surfaces are joined with the corresponding camming surfaces by corresponding first and second radius portions 356, 366. In other embodiments, other contours (e.g., convex camming surface and/or driven surface) and geometries (e.g., stepped or cylindrical surface between the camming surface and the driven surface) may be utilized. In the illustrated embodiment, either or both of the endmost surfaces of the ferrule may be provided with substantially flat (i.e., perpendicular to the central axis X) end surfaces 359, 369, for example, to simplify machining of the rear ferrule 330.

When the rear ferrule 330 is installed in the fitting assembly 300 with the first end portion 331 facing the front ferule 322, and the fitting nut 340 is pulled up with the fitting body 320 on a conduit end, the front ferrule camming surface 323 engages the first end camming surface 355 and the drive surface 343 engages the second end driven surface 367 to axially compress the ferrule between the fitting body 320 and the fitting nut 340, and to radially compress the first end portion 331 of the ferrule and its biting edge 351 against the conduit end. When the ferrule 330 is installed with the second end portion 332 facing the front ferrule 322, and the fitting nut 340 is pulled up with the fitting body 320 on a conduit end, the front ferrule camming surface 323 engages the second end camming surface 365 and the drive surface 343 engages the first end driven surface 357 to axially compress the ferrule 330 between the fitting body 320 and the fitting nut 340, and to radially compress the second end portion 332 of the ferrule and its biting edge 361 against the conduit end. This axial compression causes first and second hinge portions 352, 362 of the rear ferrule 330 to hinge radially inward, radially compressing the hinge portion adjacent the front ferrule engaging end portion of the rear ferrule into colleting engagement with the conduit end, and causing the nut engaging end portion of the rear ferrule to pivot radially outward about the hinge portion adjacent to nut engaging end portion. In the illustrated embodiment, the hinge portions 352, 362 are narrowed with respect to, or necked down from, the end portions 331, 332 of the ferrule 330, defining outer circumferential notches or recesses 353, 363 that promote radially inward hinging at the hinge portions 352, 362, in response to axial compressive forces against the relatively larger ferrule end portions 331, 332.

To facilitate two discrete radially inward hinging actions at the axially spaced hinge portions 352, 362, the central portion of the rear ferrule 330 may include an enlarged, radially extending central boss portion 333 to resist hinging deformation at this central portion and to concentrate hinging deformation at the narrowed hinge portions. The central portion of the rear ferrule 330 may also include an interior central circumferential notch or recess 334, aligned with an axial center point of the ferrule, to further facilitate spaced hinging actions at the first and second hinge portions 352, 362 by promoting an accordion-like axial compression of the ferrule 330. The dual radial inward hinging and axial compression of the ferrule 330 during fitting pull-up causes a radially outward bowing of the central portion 333 of the ferrule between the hinge portions 352, 362.

To further direct the biting edge of the body engaging ferrule end portion into biting engagement with the conduit end (not shown), the camming surfaces 355, 365 may be contoured to engage the front ferrule camming surface 323 to form a radially outward opening difference angle a1. As the fitting is pulled up, the radial compressive forces from the front ferrule camming surface 323 are applied to a narrow band of contact on the camming surface of the body engaging end portion of the ferrule at the corresponding radius portion, causing this portion to deform radially inward, diminishing the difference angle al until a larger portion of the body engaging end camming surface engages the front ferrule camming surface 323. While any suitable difference angle al may be utilized, in one exemplary embodiment, the front ferrule camming surface 323 and the first and second end camming surfaces 355, 365 are contoured to provide a difference angle of between 0° and 15°. In one such embodiment, the front ferrule camming surface 323 is disposed at an angle of about 20° with respect to the central axis X, and the first and second end camming surfaces 355, 365 are each disposed at an angle of about 15° with respect to the central axis X, thereby providing a difference angle al of about 5° when the ferrule 330 is installed in the fitting 300 with either rear ferrule end portion 331, 332 facing the front ferrule 322.

The end portions 331, 332 of the exemplary ferrule 330 are each provided an additional, axially inner biting edge or ring, extending around the ferrule interior wall, for additional biting engagement of the conduit end. In the illustrated embodiment, axially inward of the outer biting edges 351, 361 are circumferential notches or recesses 354, 364, axially spacing the outer biting edges from axially inner biting edges 358, 368, to form separate outer and inner biting rings of engagement between the body engaging end portion of the ferrule and the conduit end during pull-up. As the radial compression of the body engaging end portion during pull-up is concentrated at the outer biting edge, the outer biting edges 351, 361 may be disposed at a larger diameter than the inner biting edges 358, 368, with this difference in biting edge diameters being selected to allow the outer and inner biting edges to contact the conduit end respectively synchronous during fitting pull-up. In other embodiments (not shown), a reversible rear ferrule may be provided without these circumferential notches, such that a single, outer biting ring is formed at the outer biting edge during pull-up.

To further direct the nut engaging end portion away from engagement with the conduit end, the end portions 331, 332 of the ferrule may each be provided with a driven surface 357, 367 that engages the nut drive surface 343 to form a radially inward opening difference angle a2. As the fitting is pulled up, the axial compressive forces from the nut drive surface 343 are applied to a narrow band of contact on the nut engaging end driven surface of the ferrule at the corresponding radius portion, causing the radially inward portion of the nut engaging end portion to deform axially and radially outward, diminishing the difference angle a2 until a larger portion of the second end driven surface engages against the nut drive surface 343. While any suitable difference angle a2 may be utilized, in one exemplary embodiment, the nut drive surface 343 and the first and second end driven surfaces 357, 367 are contoured to provide a difference angle of between 0° and 20°. In one such embodiment, the nut drive surface is disposed at an angle of about 85° with respect to the central axis X, and the first and second end driven surfaces are each disposed at an angle of about 75° with respect to the central axis X, thereby providing a difference angle a2 of about 10° when the rear ferrule 330 is installed in the fitting 300 with either ferrule end portion 331, 332 facing the fitting nut drive surface 343.

According to another aspect of the present application, a two ferrule fitting having a reversible rear ferrule may be provided with a retaining structure by which the front and rear ferrules are retained with a retaining fitting component (e.g., fitting nut), as a cartridge subassembly, at least prior to assembly of the fitting component with a mating fitting component, for example, to simplify inventory control and reduce final assembly time, to shroud and protect the ferrule surfaces from damaging impacts prior to field installation, and/or to prevent omission or improper installation (e.g., backwards installation or improper mixing of fitting parts) in the field.

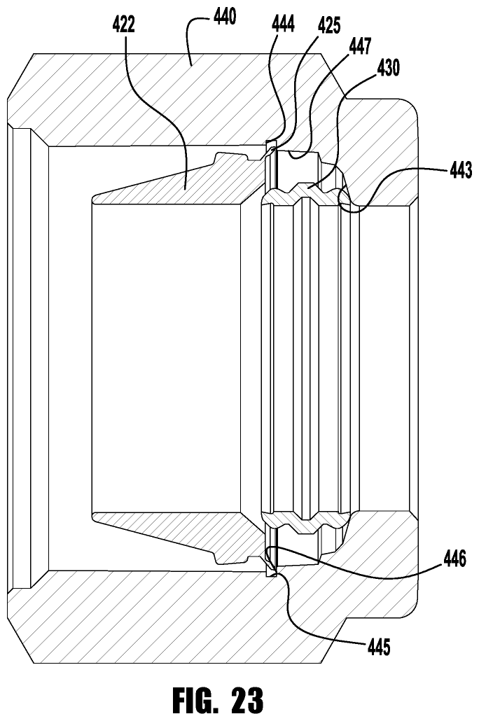

Any suitable retaining structure described herein and in the above incorporated above incorporated '810 patent, '288 application, '048 application, '694 application, and '635 application may be utilized with a two ferrule fitting having a reversible rear ferrule. FIG. 23 illustrates an exemplary nut 440, front ferrule 422, and reversible rear ferrule 430, in which the nut 440 and front ferrule 422 are similar to the embodiments of FIGS. 1-21 of the above incorporated '635 application, and may function as described in the '635 application. The front ferrule 422 includes a retaining projections 425 that initially (i.e., prior to cartridging) extends in an outboard or axially outward angled orientation such that the projection is loosely received in axial alignment with a retaining recess 445 in the fitting nut 440. To cartridge the conduit gripping device with the retaining fitting component, the retaining fitting component includes an inward facing, outboard radial wall 446 that defines an outer end of the recess 445 and extends radially inward into alignment with the end portion of the projection. When an axial outward force is applied to the front ferrule 422 to engage the projection end portion with the outboard radial wall 446, the projection is bent or pivoted axially forward and radially outward to a position in which the projection end portion radially aligns with an inboard radial wall 444 defining an inner end of the recess 445, such that the outward bent projection is axially captured in the recess between the inboard radial wall and the outboard radial wall, and the reversible rear ferrule 430 is captured between the front ferrule 422 and the nut drive surface 443.

When the nut 440 is pulled up with a fitting body on a conduit end (not shown), the outboard radial wall 446 and outboard surface 447 of the nut interior wall bend or pivot the projection 425 axially and radially inward from the laterally outward cartridged condition, such that the end portion of the projection 425 is positioned radially inward of the inboard radial wall 444 of the nut 440, to allow withdrawal of the ferrules from the nut when the nut is disassembled from the body.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

1. A preassembly for a conduit fitting, comprising:
a fitting nut;
a ferrule disposed within the fitting nut; and
a retaining feature configured to retain the ferrule with the fitting nut prior to assembly of the fitting nut with a fitting body, such that the ferrule is axially spaced from a drive surface of the fitting nut;
wherein when the fitting nut is assembled with a fitting body on a conduit end, axially movement of the ferrule toward the drive surface of the fitting nut causes deformation of the retaining feature to release the ferrule from the fitting nut.

2. The preassembly of claim 1, wherein the retaining feature comprises a retaining projection extending radially outward from the ferrule into engagement with an interior surface of the fitting nut, wherein when the fitting nut is assembled with a fitting body on a conduit end, axial movement of the ferrule toward the drive surface of the fitting nut causes the interior surface of the fitting nut to bend the retaining projection radially inward to release the ferrule from the fitting nut.

3. (canceled)

4. The preassembly of claim 2, when the fitting nut is assembled with a fitting body on a conduit end, axial movement of the ferrule toward the drive surface of the fitting nut causes the interior surface of the fitting nut to bend the retaining projection axially inward and radially inward to release the ferrule from the fitting nut.

5. The preassembly of claim 2, wherein the interior surface of the fitting nut comprises a tapered surface.

6. (canceled)

7. The preassembly of claim 2, wherein the ferrule includes an interior wall extending along a central axis through the ferrule between a first end portion proximate to a drive surface of the fitting nut and a second end portion distal to the drive surface, and an enlarged central portion disposed axially between and extending radially outward of the first and second end portions, and wherein the retaining projection extends from the enlarged central portion of the ferrule.

8.-9. (canceled)

10. The preassembly of claim 1, wherein the retaining feature comprises a retaining projection extending radially inward from an interior surface of the fitting nut into engagement with an outer surface of the ferrule, wherein when the fitting nut is assembled with a fitting body on a conduit end, axial movement of the ferrule toward the drive surface of the fitting nut causes the ferrule to deform the retaining projection radially outward to release the ferrule from the fitting nut.

11. The preassembly of claim 10, wherein the retaining projection is integral with the fitting nut.

12. The preassembly of claim 10, wherein the retaining projection comprises a retaining ring disposed in an annular groove in the fitting nut.

13. The preassembly of claim 1, wherein the ferrule includes an interior wall extending along a central axis through the ferrule between a first end portion proximate to a drive surface of the fitting nut and a second end portion distal to the drive surface, and an enlarged central portion disposed axially between and extending radially outward of the first and second end portions.

14.-19. (canceled)

20. A preassembly for a conduit fitting, comprising:
an annular fitting component;
a conduit gripping device disposed within the annular fitting component, wherein the conduit gripping device is functionally symmetrical about a plane that bisects an axial center point of the conduit gripping device; and
a retaining feature configured to retain the conduit gripping device with the annular fitting component prior to assembly of the annular fitting component with a mating fitting component.

21. The preassembly of claim 20, wherein the retaining feature comprises a retaining projection extending radially inward from an interior surface of the fitting nut, and into engagement with an enlarged central portion of the conduit gripping device.

22. The preassembly of claim 20, wherein the retaining feature comprises a retaining ring assembled with the fitting nut, the retaining ring engaging an enlarged central portion of the conduit gripping device.

23. The preassembly of claim 21, wherein the retaining feature engages an inboard radial surface of the enlarged central portion of the conduit gripping device.

24. The preassembly of claim 21, wherein the retaining feature engages an outer circumferential surface of the enlarged central portion of the conduit gripping device.

25. The preassembly of claim 20, wherein the retaining feature comprises a retaining projection extending radially outward from an enlarged central portion of the conduit gripping device, and into engagement with an interior surface of the fitting nut.

26. A ferrule for a conduit fitting, the ferrule comprising:
an interior wall extending along a central axis through the ferrule between first and second end portions so that the ferrule can be installed over a conduit end;
an enlarged central portion disposed axially between and extending radially outward of the first and second end portions; and
a retaining projection extending radially outward from the enlarged central portion;
wherein the ferrule is functionally symmetrical about a plane that bisects an axial center point of the ferrule.

27. The ferrule of claim 26, wherein the first end portion of the ferrule includes an axially outer first end driven surface disposed at a first angle between 70° and 90° with respect to the central axis, and an axially inner first end camming surface disposed at a second angle between 0° and 40° with respect to the central axis, and the second end portion of the ferrule including an axially outer second end driven surface disposed at a third angle substantially equal to the first angle, and an axially inner second end camming surface disposed at a fourth angle substantially equal to the second angle.

28. The ferrule of claim 26, wherein the first end portion includes a first end camming surface disposed at a first angle with respect to the central axis and the second end portion includes a second end driven surface disposed at a second angle with respect to the central axis, the second angle being greater than the first angle.

29. The ferrule of claim 28, further comprising a first narrowed portion axially inward of and necked down from the first end portion and a second narrowed portion axially inward of and necked down from the second end portion.

30. The ferrule of claim 26, wherein the first end portion of the ferrule includes an axially outer first end driven surface disposed at a first angle with respect to the central axis, an axially inner first end camming surface disposed at a second angle with respect to the central axis, the second angle being smaller than the first angle, and a first radius portion joining the first end driven surface with the first end camming surface, and the second end portion of the ferrule includes an axially outer second end driven surface disposed at a third angle substantially equal to the first angle, an axially inner second end camming surface disposed at a fourth angle substantially equal to the second angle, and a second radius portion joining the second end driven surface with the second end camming surface.

31.-38. (canceled)
